(19) United States
(12) Patent Application Publication
(10) Pub. No.: US 2023/0283223 A1
(43) Pub. Date: Sep. 7, 2023

(54) VERSATILE SOLAR PANEL RAIL MOUNTING BRACKET

(71) Applicant: Doug Baird, Vidalia, GA (US)

(72) Inventor: Doug Baird, Vidalia, GA (US)

(21) Appl. No.: 18/117,938

(22) Filed: Mar. 6, 2023

Related U.S. Application Data
(60) Provisional application No. 63/316,666, filed on Mar. 4, 2022.

(51) Int. Cl. H02S 20/23

(52) U.S. Cl. CPC H02S 20/23

(57) ABSTRACT

An improved mounting bracket provides stabile and reliable solar panel mounting rail height adjustment and easier access to mounting holes on both sides of the mounting rail. The mounting bracket includes a vertical member extending upwardly from the upper surface of the base member such that the base and vertical members form a T-shaped cross section. The vertical member has a vertical slot and an inner surface with a plurality of elongated grooves that cooperate with corresponding elongated grooves on the mounting rail. The elongated solar panel mounting rail is coupled to the roof structure using a plurality of the mounting brackets, with the distance between the mounting rail and the roof structure being adjustable through the interaction of the cooperating grooves prior to tightening the mounting bolts. A system for mounting solar panels to a roof structure includes both the mounting rails and the mounting brackets.

### REFERENCE TO RELATED APPLICATIONS

This application claims priority to and the benefit of U.S. Provisional Patent Application Ser. No. 63/316,666, filed Mar. 4, 2022, the entire content of which is incorporated herein by reference.

### FIELD OF THE INVENTION

This invention relates generally to solar panels and, in particular, to a mounting brackets adapted to secure solar panel mounting rails.

### BACKGROUND OF THE INVENTION

In addition to residential installations, solar panels have become very popular for various industrial applications. One such application is in the poultry industry, wherein rooftop panels are used to run fans to provide ventilation. The use of solar energy for this purpose is very practical, since the panels provide sufficient electrical power with a significant cost savings.

FIG. 1 is a simplified drawing that shows the roof of a poultry building 100, with the understanding that similar structures may be used for different purposes while still benefiting from the inventions described herein. Basically, a plurality of rafters 102 connect to a ridge beam 104, which is then covered with a plurality of spaced-apart slats 106, 108, 110 and covered with a tin or other metal roof (not shown). The slats are typically wooden 1×4s, and more would typically be used than are depicted in FIG. 1.

For solar panel mounting, rigid, extruded aluminum rails are first fastened to the slat through the metal roof. The location of the slats is relatively straightforward are the roofs fasteners may be used for positioning. For example, a rail may be aligned with slats 106 and 108, with the solar panels then being attached to the rails. This system is described in my U.S. Utility patent application Ser. No. 16/392,372, incorporated herein by reference in its entirety.

A Figure from the above-referenced '372 Application is included herewith. A section of metal roof is shown at 202, and a slat is depicted at 204. A solar panel is illustrated at 206, mounted to rail 102 using bracket 208. Also shown is a wiring channel 306 mounted to the upper side of the rail 102 using fasteners 308.

To mount the rails 102 to the roof structure, L-shaped brackets 103 are currently used. A problem is that these existing brackets are not readily adjustable, neither lengthwise along the mounting rails, nor height-wise relative to the roof surface. This is problematic because many commercial roofs are poorly constructed, such that outer roof surface may be wavy or uneven. Since the brackets used to mount the solar-panel rails are non-adjustable, the rails are also uneven, leading to panel mounting challenges.

### SUMMARY OF THE INVENTION

This invention improves upon existing solar panel mounting systems by providing an improved mounting bracket providing stabile and reliable mounting rail height adjustment and easier access to mounting holes on both sides of the mounting rail.

The elongated solar panel mounting rail has an upper surface adapted to receive a solar panel for mounting thereon, a side surface with an elongated slot and a plurality of elongated grooves adjacent the slot. Mounting bolts have a head portion adapted for capture by the slot and a threaded shaft configured to receive a mounting nut.

The mounting bracket has a base member with an upper surface, a lower surface, and a plurality of through-holes. The lower surface of the base member is configured for mounting against a roof structure using screw fasteners extending through the through-holes in the base member of the mounting bracket. The mounting bracket further includes a vertical member extending upwardly from the upper surface of the base member such that the base and vertical members form a T-shaped cross section.

The vertical member of the mounting bracket has an outer surface and an inner surface, and wherein the inner surface has a plurality of elongated grooves that cooperate with the elongated grooves adjacent the slot in the mounting bracket. A vertical slot in the vertical member is configured to receive a threaded shaft of one of the mounting bolts.

Wherein the existing elongated solar panel mounting rail is coupled to the roof structure using a plurality of the mounting brackets, with the distance between the mounting rail and the roof structure being adjustable through the interaction of the cooperating grooves prior to tightening the mounting bolts.

In the preferred embodiment, the elongated grooves on the inner surface of the mounting bracket are above and below the vertical slot in the vertical member. Indeed, the vertical slot may be surrounded by the grooving on the inner surface of the mounting bracket.

The base member has through-holes on both sides of the vertical member, and the through-holes in the base member on the side of the inner surface of the vertical member are slotted toward and away from the inner surface of the vertical member. An electrically insulative pad may be provided on the lower surface of the base member.

A system for mounting solar panels to a roof structure includes both the mounting rails and the mounting brackets.

### BRIEF DESCRIPTION OF THE DRAWINGS

FIG. 1 is a simplified drawing that shows the roof of a poultry building;

FIG. 2 is a drawing that shows a prior-art rail mounting structure for solar panels;

FIG. 3 is a photo showing an improved bracket design according to the invention;

FIG. 4 is a photo that shows a short prototype rail with two of the new brackets; and

FIG. 5 is a photo that shows the grooved side of the bracket and connectors.

### DETAILED DESCRIPTION OF THE INVENTION

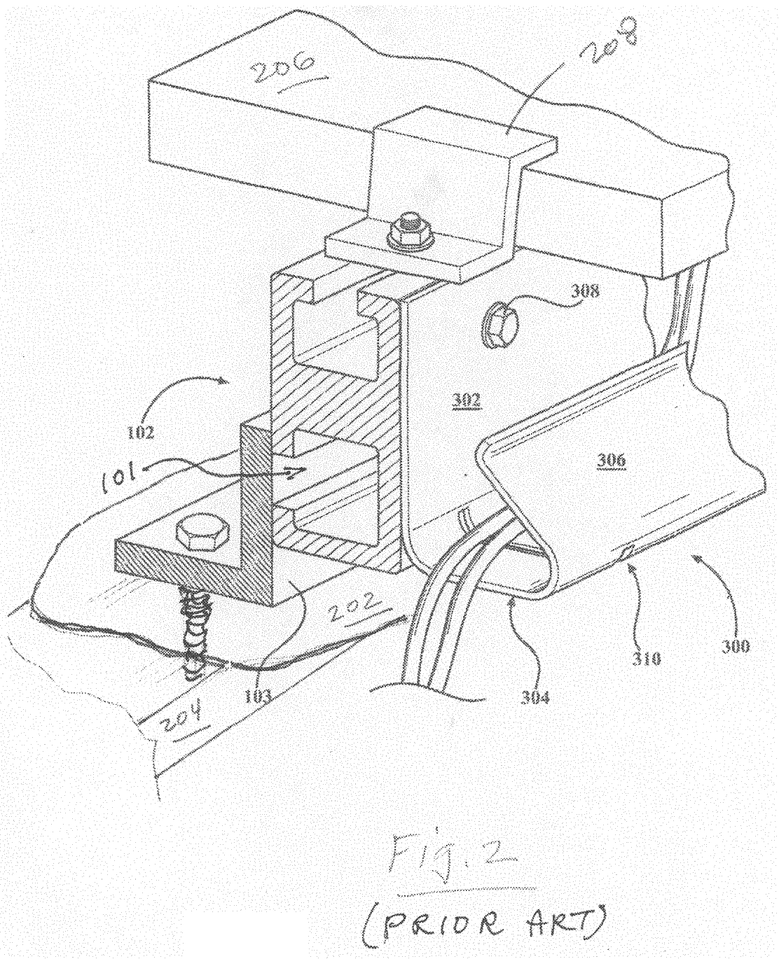

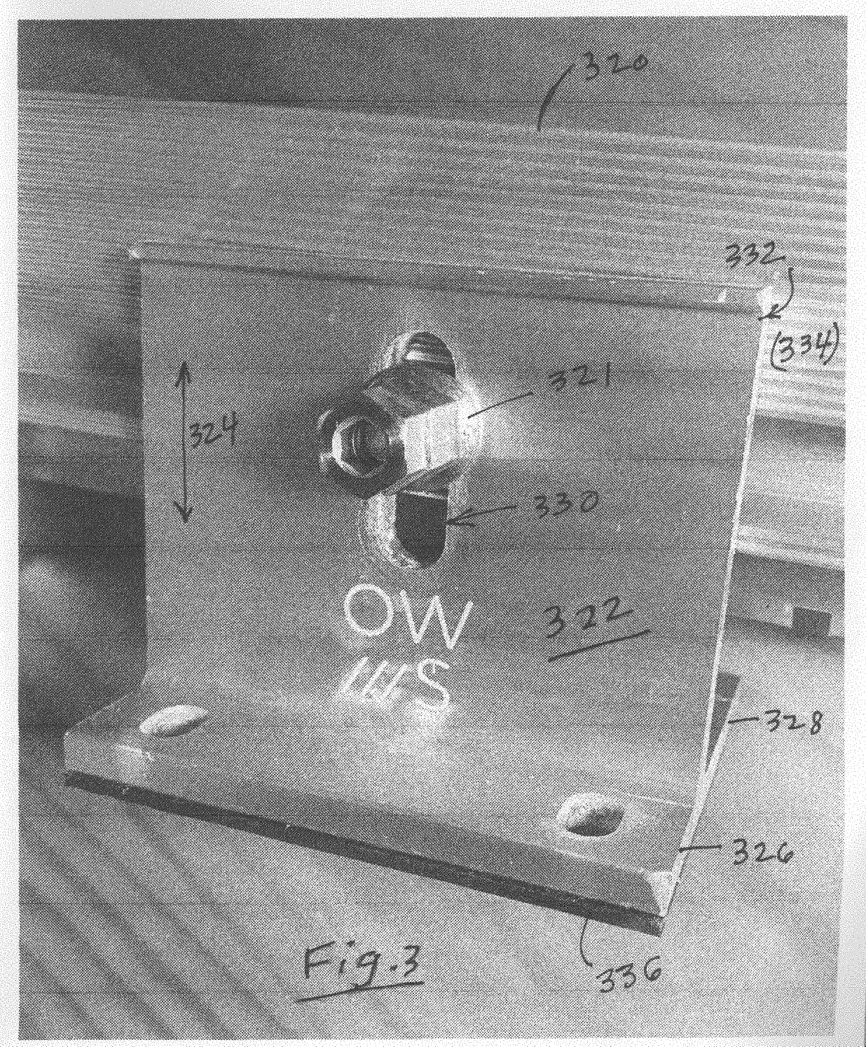

This invention improves upon existing solar panel mounting structures by providing a more versatile bracket than the one shown in FIG. 2 as 103. FIG. 3 is a photo showing the new bracket design. As opposed to an L-shape, the bracket is T-shaped with mounting holes on both sides 326, 328 of the base. The upright portion 324 is taller, and the back side includes grooves 332 that cooperate with grooves 334 formed in the side of the rail 320. A vertical slot 330 formed in the bracket allows the bracket to move up and down relative to the rail 320 before tightening fastener 321, locking it into a desired vertical position based on the interaction of the grooves 332, 334. This also eases tightening of fastener 321, which can almost be hand-tightened in some cases. Indeed, bolts with wings or wingnuts may alternatively be provided. A rubbery pad 336 may also be used to enhance gripping to the roof surface and provide electrical isolation.

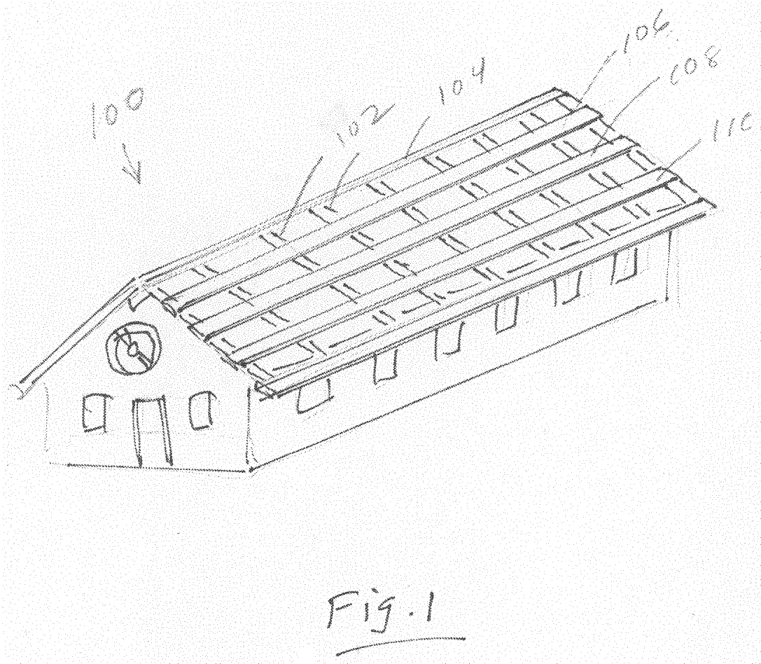

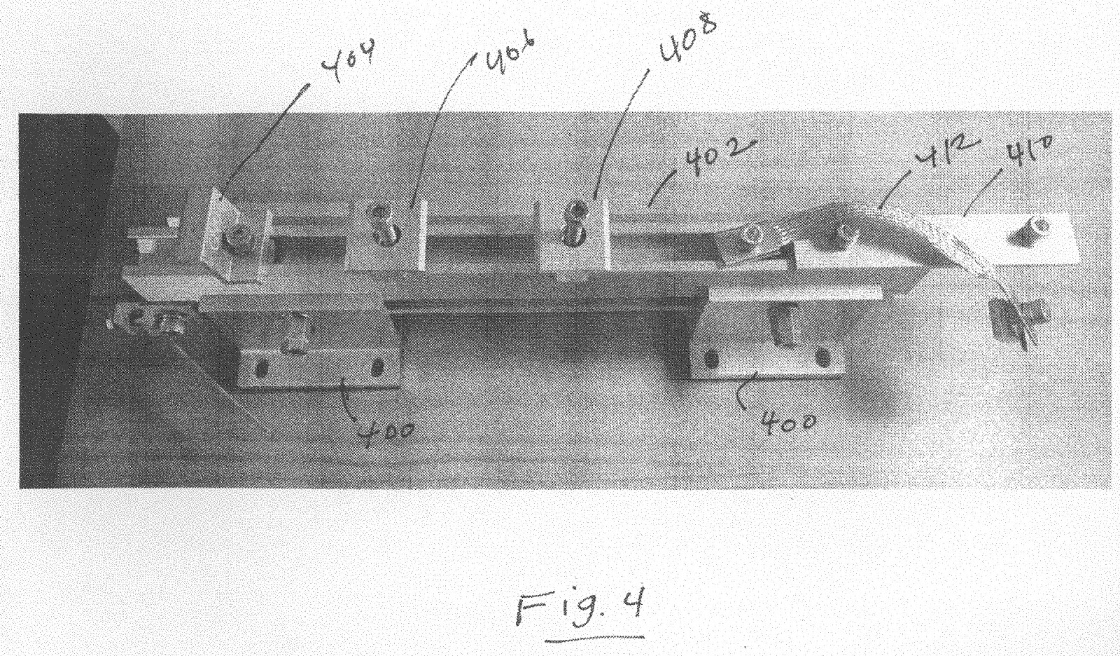

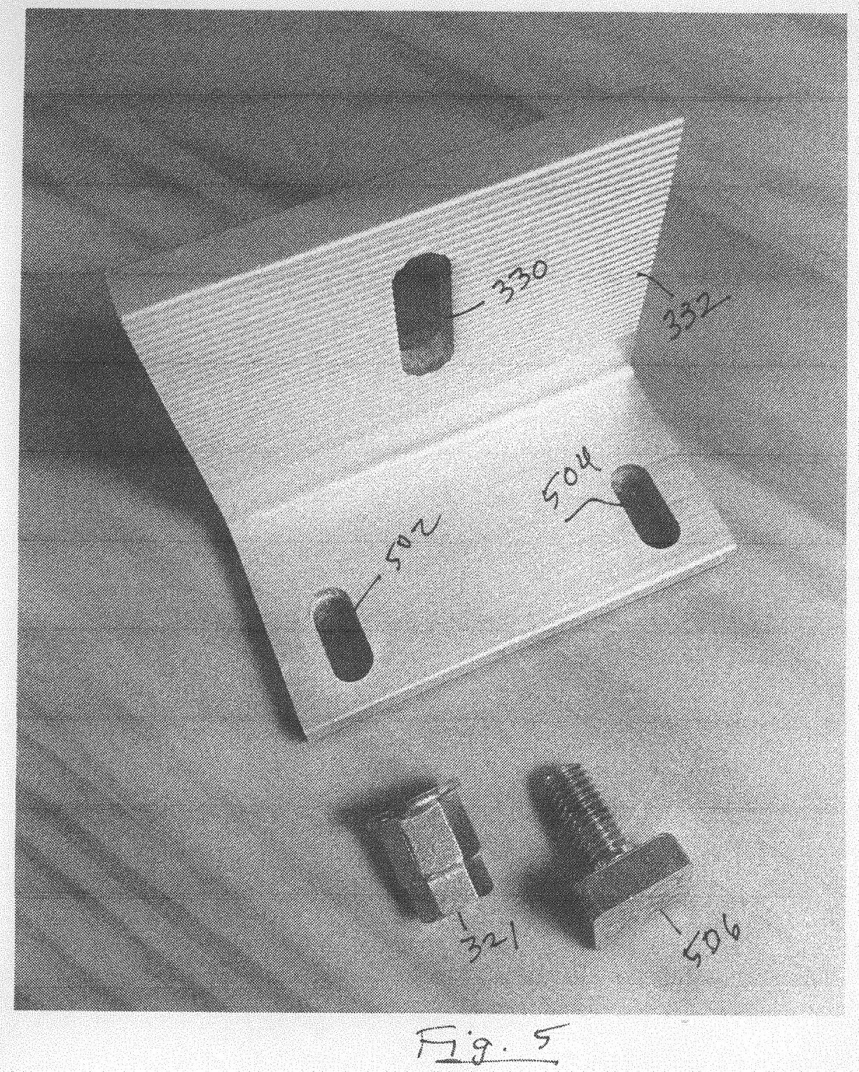

FIG. 4 is a photo that shows a short prototype rail 402 with two of the new brackets 400. Different panel mounting clips 404, 406, 408 are also shown, as well as a connector bar 410 and optional grounding strap 412 used to join adjacent rails. FIG. 5 is a photo that shows the grooved side of the bracket and connectors. A couple further advantages should be noted here as well. First, mounting hole 502, 504 on this side of the bracket are preferably slot-shaped, enabling fasteners to drilled at an angle. This is advantageous to access the holes if the wiring channel 306 in FIG. 1 is provided. Additionally, the head of the bolt 506 is square and dimensioned to easily slide in groove 101 shown in FIG. 1.

With these improvements, the installer can lay an entire rail on the roof and move loosened brackets laterally and vertically so that the rail (which may be 10-20 feet long), mounts with uniformity relative to the roof surface and underlying mounting structures such a wood slats.

1. A mounting bracket adapted for use with an existing elongated solar panel mounting rail having an upper surface adapted to receive a solar panel for mounting thereon, a side surface with an elongated slot and a plurality of elongated grooves adjacent the slot, and plurality of mounting bolts, each with a head portion adapted for capture by the slot and a threaded shaft configured to receive a mounting nut, the mounting bracket comprising:
a base member having an upper surface, a lower surface, and a plurality of through-holes;
wherein the lower surface of the base member is configured for mounting against a roof structure using screw fasteners extending through the through-holes in the base member of the mounting bracket;
a vertical member extending upwardly from the upper surface of the base member such that the base and vertical members form a T-shaped cross section;
a vertical slot in the vertical member configured to receive a threaded shaft of one of the mounting bolts;
wherein the vertical member has an outer surface and an inner surface, and wherein the inner surface has a plurality of elongated grooves that cooperate with the elongated grooves adjacent the slot in the mounting bracket; and
wherein the existing elongated solar panel mounting rail is coupled to the roof structure using a plurality of the mounting brackets, with the distance between the mounting rail and the roof structure being adjustable through the interaction of the cooperating grooves prior to tightening the mounting bolts.

2. The mounting bracket of claim 1, wherein the base member has through-holes on both sides of the vertical member.

3. The mounting bracket of claim 2, wherein the through-holes in the base member on the side of the inner surface of the vertical member are slotted toward and away from the inner surface of the vertical member.

4. The mounting bracket of claim 1, including an electrically insulative pad on the lower surface of the base member.

5. The mounting bracket of claim 1, including elongated grooves above and below the vertical slot in the vertical member.

6. The mounting bracket of claim 1, including an existing elongated solar panel mounting rail having an upper surface adapted to receive a solar panel for mounting thereon, a side surface with an elongated slot and a plurality of elongated grooves adjacent the slot, and plurality of mounting bolts, each with a head portion adapted for capture by the slot and a threaded shaft configured to receive a mounting nut.

7. A system for mounting solar panels to a roof structure, comprising:
a mounting bracket having an upper surface adapted to receive a solar panel for mounting thereon;
wherein the mounting bracket has a side surface with an elongated slot to receive the head of a mounting bolt having a threaded shaft that extends away from the side surface to receive a mounting bolt;
wherein the side surface of the mounting bracket has a plurality of elongated grooves adjacent the slot;
a mounting bracket comprising a base member having an upper surface, a lower surface, and a plurality of through-holes;
wherein the lower surface of the base member is configured for mounting against a roof structure using screw fasteners extending through the through-holes in the base member of the mounting bracket;
a vertical member extending upwardly from the upper surface of the base member such that the base and vertical members form a T-shaped cross section;
a vertical slot in the vertical member configured to receive a threaded shaft of one of the mounting bolts;
wherein the vertical member has an outer surface and an inner surface, and wherein the inner surface has a plurality of elongated grooves that cooperate with the elongated grooves adjacent the slot in the mounting bracket; and
wherein the elongated solar panel mounting rail is coupled to the roof structure using a plurality of the mounting brackets, with the distance between the mounting rail and the roof structure being adjustable through the interaction of the cooperating grooves prior to tightening the mounting bolts.

8. The mounting bracket of claim 7, wherein the base member has through-holes on both sides of the vertical member.

9. The mounting bracket of claim 8, wherein the through-holes in the base member on the side of the inner surface of the vertical member are slotted toward and away from the inner surface of the vertical member.

10. The mounting bracket of claim 7, including an electrically insulative pad on the lower surface of the base member.

11. The mounting bracket of claim 7, including elongated grooves above and below the vertical slot in the vertical member.
